(19) United States
(12) Patent Application Publication
(10) Pub. No.: US 2022/0180300 A1
(43) Pub. Date: Jun. 9, 2022

(54) SYSTEMS AND METHODS FOR PACKAGE DELIVERY INFRASTRUCTURE

(71) Applicant: KAEBOX L.L.C., Middletown, DE (US)

(72) Inventor: Mohammad Ahmad ALHAJAHJEH, Arlington, VA (US)

(21) Appl. No.: 17/544,483

(22) Filed: Dec. 7, 2021

Related U.S. Application Data
(60) Provisional application No. 63/122,211, filed on Dec. 7, 2020.

(51) Int. Cl. G06Q 10/08

(52) U.S. Cl. CPC G06Q 10/083

(57) ABSTRACT

This disclosure provides systems, methods, and apparatus for a package delivery infrastructure. A server receives a request for a delivery transaction from a requesting device. The server, based on the request, determines a pick-up and drop-off location. The server determines an identity of a selected delivery entity based on request data and current locations of several delivery entities. The server transmits a delivery message to the selected delivery entity, the delivery message including at least one of a pick-up location, a drop-off location, and identity information of a user associated with the requesting device. The server transmits a confirmation message to the requesting device including identity information of the selected delivery entity.

### CROSS-REFERENCE TO RELATED APPLICATIONS

This application claims the benefit of U.S. Provisional Application No. 63/122,211, entitled “Systems and Methods for Package Delivery Infrastructure,” filed Dec. 7, 2020, which is incorporated by reference herein in its entirety.

### TECHNICAL FIELD

This disclosure relates to the field of computer systems, in particular computer systems for establishing efficient delivery infrastructures.

### DESCRIPTION OF THE RELATED TECHNOLOGY

Computer systems managing delivery infrastructure include sub-systems for delivery scheduling and delivery entity selection. Delivery infrastructure involving last-mile delivery, in particular, employs several dedicated delivery entities for point-to-point pick-up and drop-off of packages. Such infrastructure creates inefficiencies that increase both monetary and fuel costs.

### SUMMARY

In one aspect of the disclosure, a system includes a server system, the server system including at least one network interface configured to communicate over a communication network, at least one processor, and instructions stored in non-transitory machine-readable media, the instructions configured to cause the server system to perform operations including: receive, over the at least one network interface, a request for a delivery transaction from a requesting device, the request including delivery request data including at least one of identity information of a user associated with the requesting device, origination information associated with the request, and a destination information associated with the request. The operations further including determine, based at least in part on the delivery request data, a pick-up location and a drop-off location. The operations further including, determine, based at least in part on the delivery request data and a database including a set of delivery entities and delivery entity information associated with each delivery entity of the set of delivery entities, the delivery entity information including in part current location information of the corresponding delivery entity, an identity of a selected delivery entity from the set of delivery entities. The operations also including, transmit, over the at least one network interface, a delivery message to a network address associated with the selected delivery entity, the delivery message including at least one of the pick-up location, the drop-off location, and the identity information of the user, and transmit, over the at least one network interface, a confirmation message to the requesting device, including an identity of the selected delivery entity.

In some embodiments, the instructions cause the server system to determine, based on a comparison of the pick-up location with current location information associated with the set of delivery entities in the database, a subset of delivery entities, each of which have a corresponding current location that is within a predetermined distance from the pick-up location, wherein the selected delivery entity has a corresponding current location that has the a lowest cost function in relation to the pick-up location from among the subset of delivery entities. In some embodiments, the instructions cause the server system to determine, based on a comparison of the pick-up location with current location information associated with the set of delivery entities in the database, a subset of delivery entities, each of which have a corresponding current location that is within a predetermined distance from the pick-up location; send, over the at least one network interface, a polling message to a network address associated with each delivery entity in the subset of delivery entities; and receive, over the at least one network interface, at least one polling response message from at least one delivery entity from the subset of delivery entities, wherein the selected delivery entity corresponds to a first delivery entity from which a polling response message is received.

In some embodiments, the instructions cause the server system to receive, over the at least one network interface, a downtime status message from each of a subset of delivery entities of the set of delivery entities, wherein the selected delivery entity belongs to the subset of delivery entities. In some embodiments, the instructions cause the server system to receive, over the at least one network interface, a en-route status from each of a subset of delivery entities of the set of delivery entities, the en-route status indicating a corresponding delivery entity currently engaged in executing a ride-share service; and determining, from the subset of delivery entities, the selected delivery entity, wherein the selected delivery entity has at least one of its current location or destination location with the a lowest cost function in relation to the pick-up location.

In some embodiments, the delivery request data includes mode of shipment information, and wherein the instructions cause the server system to determine the drop-off location based on the mode of shipment information. In some embodiments, the mode of shipment information indicates a shipment carrier, wherein the instructions cause the server system to determine the drop-off location as a location associated with the shipment carrier that is nearest to the pick-up location. In some embodiments, the destination information associated with the request includes a mailing address associated with a shipment, wherein the instructions cause the server system to generate shipment label information specific to the shipment carrier based on the mailing address; and transmit, over the at least one network interface, the shipment label information to the network address associated with the selected delivery entity.

In some embodiments, the mode of shipment information indicates a courier mode, wherein the destination information includes a location for delivery, wherein the instructions cause the server system to determine the drop-off location as the location for delivery. In some embodiments, the instructions cause the server system to receive, over the at least one network interface, another request for a delivery transaction while the delivery entity is en-route to the pick-up location or the drop-off location; generate a modified route, the modified route modifying a current route to include another pick-up or another drop-off location associated with the another request; and transmit, over the at least one network interface, the modified route to the selected delivery entity. In some embodiments, the location that has the lowest cost function in relation to the pick-up location is determined at least in part based on one or more of a distance to the pick-up location, a time to the pick-up location, an efficiency of a route to the pick-up location, an efficiency of resources to the pick-up location.

In some embodiments, the instructions cause the server system to receive, over the at least one network interface from the requesting device, a first photo of a package to be picked up from the pick-up location; transmit, over the at least one network interface to the selected delivery entity, an instruction to capture a photo of the package at the pick-up location; receive, over the at least one network interface from the selected delivery entity, a second photo of the package at the pick-up location; transmit, over the at least one network interface to the requesting device, the second photo; receive, over the at least one network interface from the requesting device, a verification message; and transmit, over the at least one network interface to the selected delivery entity, an instruction to proceed with delivering the package to the drop-off location.

In some embodiments, the instructions cause the server system to receive, over the at least one network interface from the requesting device, a first photo of a package to be picked up at the pick-up location; transmit, over the at least one network interface to the selected delivery entity, the first photo; receive, over the at least one network interface, a verification message from the selected delivery entity indicating that the package at the pick-up location matches the first photo; receive, over the at least one network interface, a second photo of the package at the pick-up location from the selected delivery entity; and transmit, over the at least one network interface, the first photo and the second photo to a device associated with a recipient at the drop-off location.

In another aspect of the disclosure a mobile device includes at least one network interface configured to communicate over a communication network, at least one processor, and instructions stored in non-transitory machine-readable media, the instructions configured to cause the mobile device to perform operations including receive, over the at least one network interface, a delivery message from a server system, the delivery message including at least one of a pick-up location, a drop-off location, and identity information of a user associated with the delivery message. The operations further including annunciate, over at least one user interface of the mobile device, a receipt of the delivery message. The operations also including receive, over the at least one user interface, an instruction indicating acceptance of the delivery message, and transmit, responsive to receiving the instruction, over at least one network interface of the mobile device, an acceptance message to the server system. The operations further including receive, over the at least one network interface, delivery package information from the server system, and transmit, to a mobile printer, packaging label information based at least in part on the delivery package information from the server system.

In some embodiments, the instructions cause the mobile device to receive, from a mobile weighing scale, weight information of a package associated with the delivery package information and generate the packaging label information based at least in part on the weight information. In some embodiments, the instructions cause the mobile device to launch, responsive to receiving the instruction indicating acceptance of the delivery message, a mapping application providing directions from a current location of the mobile device to the pick-up location. In some embodiments, the instructions cause the mobile device to launch, responsive to receiving the delivery package information, a mapping application providing directions from the pick-up location to the drop-off location. In some embodiments, the instructions cause the mobile phone device to receive, over the at least one network interface, another delivery message from the server system while the mobile device is in route to at least one of the pick-up location or the drop-off location associated with the delivery message; receive, over the at least one user interface, an instruction indicating acceptance of the delivery message; and modify a route from the a current location to at least one of the pick-up location or the drop-off location associated with the delivery message to include another pick-up location or another drop-off location associated with the delivery message.

In another aspect of the disclosure, a method includes receiving, by a server system over at least one network interface, a request for a delivery transaction from a requesting device, the request including delivery request data including at least one of identity information of a user associated with the requesting device, origination information associated with the request, and a destination information associated with the request. The method further includes determining, by the server system, based at least in part on the delivery request data, a pick-up location and a drop-off location. The method also includes determining, by the server system, based at least in part on the delivery request data and a database including a set of delivery entities and delivery entity information associated with each delivery entity of the set of delivery entities, the delivery entity information including in part current location information of the corresponding delivery entity, an identity of a selected delivery entity from the set of delivery entities. The method further includes transmitting, by the server system over the at least one network interface, a delivery message to a network address associated with the selected delivery entity, the delivery message including at least one of the pick-up location, the drop-off location, and the identity information of the user, and transmitting, by the server system over the at least one network interface, a confirmation message to the requesting device, including an identity of the selected delivery entity.

In some embodiments, the method includes determining, by the server system, based on a comparison of the pick-up location with current location information associated with the set of delivery entities in the database, a subset of delivery entities, each of which have a corresponding current location that is within a predetermined distance from the pick-up location, wherein the selected delivery entity has a corresponding current location that has the lowest cost function in relation to the pick-up location from among the subset of delivery entities. In some embodiments, the method includes determining, by the server system, based on a comparison of the pick-up location with current location information associated with the set of delivery entities in the database, a subset of delivery entities, each of which have a corresponding current location that is within a predetermined distance from the pick-up location; and transmitting, by the server system over the at least one network interface, a polling message to a network address associated with each delivery entity in the subset of delivery entities; and receiving, by the server system over the at least one network interface, at least one polling response message from at least one delivery entity from the subset of delivery entities, wherein the selected delivery entity corresponds to a first delivery entity from which a polling response message is received.

In some embodiments, the method further includes receiving, by the server system over the at least one network interface, a downtime status message from each of a subset of delivery entities of the set of delivery entities, wherein the selected delivery entity belongs to the subset of delivery entities. In some embodiments, the method further includes receiving, by the server system over the at least one network interface, an en-route status from each of a subset of delivery entities of the set of delivery entities, the en-route status indicating a corresponding delivery entity currently engaged in executing a ride-share service; determining, by the server system, from the subset of delivery entities, the selected delivery entity, wherein the selected delivery entity has at least one of its current location or destination location with the lowest cost function in relation to the pick-up location.

In some embodiments, the delivery request data includes mode of shipment information, and the method further includes determining, by the server system, the drop-off location based on the mode of shipment information. In some embodiments, the mode of shipment information indicates a shipment carrier, and the method further includes determining, by the server system, the drop-off location as a location associated with the shipment carrier that is nearest to the pick-up location. In some embodiments, the destination information associated with the request includes a mailing address associated with a shipment, and the method further includes generating, by the server system, shipment label information specific to the shipment carrier based on the mailing address; and transmitting, by the server system over the at least one network interface, the shipment label information to the network address associated with the selected delivery entity. In some embodiments, the mode of shipment information indicates a courier mode, and wherein the destination information includes a location for delivery, and the method further includes determining, by the server system, the drop-off location as the location for delivery.

In some embodiments, the method further includes receiving, by the server system over the at least one network interface, another request for a delivery transaction while the delivery entity is en-route to the pick-up location or the drop-off location; generating, by the server system, a modified route, the modified route modifying a current route to include another pick-up or another drop-off location associated with the another request; and transmitting, by the server system over the at least one network interface, the modified route to the selected delivery entity. In some embodiments, the location that has the lowest cost function in relation to the pick-up location is determined based at least in part on one or more of a distance to the pick-up location, a time to the pick-up location, an efficiency of a route to the pick-up location, an efficiency of resources to the pick-up location.

In another aspect of the disclosure, a method, includes receiving, by a mobile device associated with a delivery entity over at least one network interface, a delivery message from a server system, the delivery message including at least one of a pick-up location, a drop-off location, and identity information of a user associated with the delivery message. The method further includes annunciating, by the mobile device over at least one user interface of the mobile device, a receipt of the delivery message. The method further includes receiving, by the mobile device over the at least one user interface, an instruction indicating acceptance of the delivery message. The method also includes transmitting, by the mobile device, responsive to receiving the instruction, over at least one network interface of the mobile device, an acceptance message to the server system. The method further includes receiving, by the mobile device over the at least one network interface, delivery package information from the server system, and transmitting, by the mobile device to a mobile printer, packaging label information based at least in part on the delivery package information from the server system.

In some embodiments, the method further includes receiving, by the mobile device from a mobile weighing scale, weight information of a package associated with the delivery package information; and generating, by the mobile device, the packaging label information based at least in part on the weight information. In some embodiments, the method further includes launching, by the mobile device, responsive to receiving the instruction indicating acceptance of the delivery message, a mapping application providing directions from a current location of the mobile device to the pick-up location. In some embodiments, the method further includes launching, by the mobile device, responsive to receiving the delivery package information, a mapping application providing directions from the pick-up location to the drop-off location.

In some embodiments, the method further includes receiving, by the mobile device over the at least one network interface, another delivery message from the server system while the mobile device is in route to at least one of the pick-up location or the drop-off location associated with the delivery message, receiving, by the mobile device over the at least one user interface, an instruction indicating acceptance of the another delivery message; and modifying, by the mobile device, a route from the current location to at least one of the pick-up location or the drop-off location associated with the delivery message to include another pick-up location or another drop-off location associated with the another delivery message.

### BRIEF DESCRIPTION OF THE DRAWINGS

FIG. 1 shows an example delivery infrastructure.

FIG. 2 shows a flow diagram of an example package delivery process.

FIG. 3 shows a flow diagram of an example process for selecting a delivery entity.

FIG. 4 shows a schematic of an example package delivery infrastructure including chaining of package deliveries.

FIG. 5 shows a schematic of an example package delivery server.

FIG. 6 shows a schematic of an example communication device.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to as well as the range greater than ‘x’ and less than The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

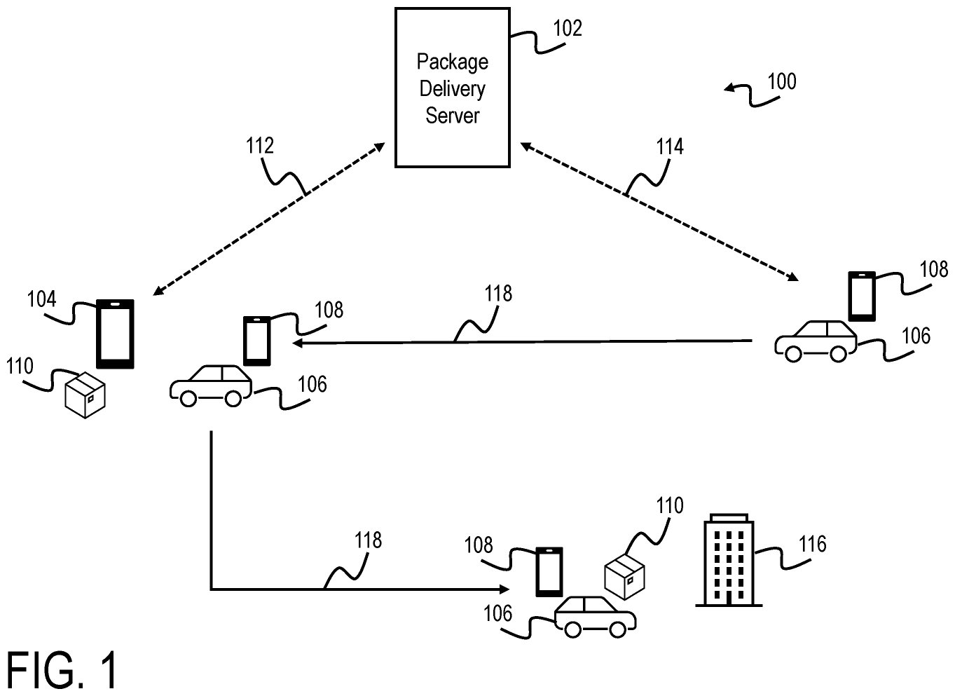

FIG. 1 shows an example delivery infrastructure 100. In particular, the delivery infrastructure 100 includes a package delivery server 102, a requesting device 104, a delivery entity 106, and a communication device 108 associated with the delivery entity 106. The delivery server 102 (discussed in further detail below) can manage delivery requests received from the requesting device 104 and facilitate the pick-up of the deliver package by the delivery entity 106 from a location specified by the requesting device 104. For example, a user can use the requesting device 104 to send a delivery request 112 for a package 110. The delivery request can include delivery request data, which can indicate a mode of shipment, such as, for example, courier, mail via a shipment carrier, etc., the delivery origination information and the delivery destination information. The delivery server 102 can select the delivery entity 106 for delivering the package 110, and send a delivery message 114 to the communication device 108 associated with the delivery entity 106 and request the delivery entity to pick-up the package 110 from a pick-up location and drop-off the package at a destination location 116. The delivery entity 106, or an application running on the communication device 108 associated with the delivery entity 106 can provide a route 118 to the delivery entity to facilitate the pick-up of the package 110 from the pick-up location and deliver the package 110 at the drop-off location 116. In some examples, the delivery entity 106 can be a person driving a vehicle. In some other examples, the delivery entity 106 can be an arial drone operated remotely by a controller or automatically controlled by a controller on the arial drone. In still further examples, the delivery entity 106 can be a self-driving or autonomous vehicle.

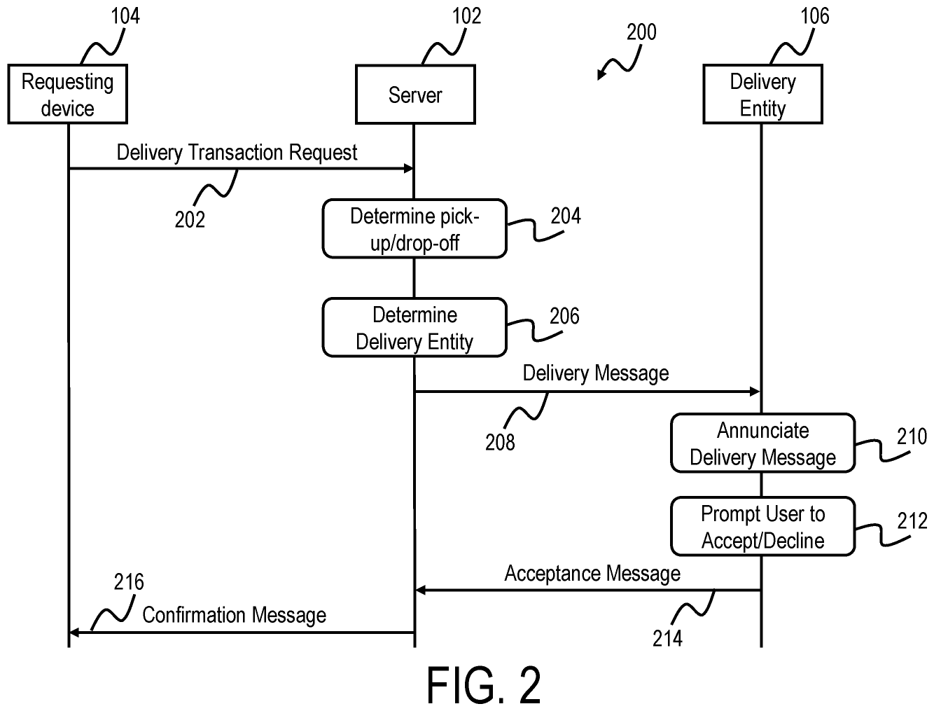

FIG. 2 shows a flow diagram of an example package delivery process 200. The process 200 can be executed, for example, by the delivery infrastructure 100 shown in FIG. 1. The process 200 can include communications between the requesting device 104, the package delivery server 102, and the delivery entity 106 (or the communication device 108 associated with the delivery entity 106). The requesting device 104 can send a request 202 for a delivery transaction to the package delivery server 102. The requesting device 104 can be a personal computer, a smart phone, a digital assistant, or any other type of electronic device that can receive instructions from a user of the device, and send the request 202 to the server over a communication network. The request 202 can include, for example, at least one of identity information of the user associated with the requesting device 104 and package information such as origination information and destination information. The identity information can include a unique identifier of the user, which unique identifier the server 102 can use to access a user database and retrieve user information such as name, address, transaction history, and other account information associated with the user. The identity information can also include information from the requesting device 104, such as, for example, the current location of the requesting device 104, the type of device (e.g., smart phone, personal computer, digital assistant, etc.). The origination information can include the pick-up location of the package and the destination information can include the destination address of the package. As an example, the origination information can correspond to the residence address of the user associated with the requesting device 104, or the current location of the user based on the current location of the requesting device 104. The destination information can include the actual address of where the package is to be delivered. For example, if the request is for a courier delivery to a local address, then the destination information can include the local address or a landmark associated with the local address. The destination information may also include a mailing address in addition to instructions that the package is to be mailed using a shipment carrier (e.g., United States Postal Service (USPS), UPS, FEDEX, etc.).

The package delivery server 102, upon receiving the request 202 can validate and/or authenticate the user based on the identity information included in the request, or by initiating additional communication with the requesting device 104 to validate and/or authenticate the request 202. The package delivery server 102 can also determine (204) the pick-up and drop-off locations the delivery request. The package delivery server 102 can determine the pick-up and drop-off locations based in part on the request data received in the request 202. For example, the package delivery server 102 can determine the pick-up location based on the current address associated with the user in the user database. In another example, the package delivery server 102 can determine the pick-up location to be the current location of the requesting device 104 associated with the user. In yet another example, the package delivery server 102 can determine the pick-up location as a location included in the request data received with the request 202. The package delivery server 102 can determine the drop-off location, in part, based on the mode of shipment included in the request. For example, the package delivery server 102 can determine the drop-off location to be the nearest vendor/office of the shipment carrier included in the request. In another example, the package delivery server 102 can determine the drop-off location to be a location explicitly specified in the request 202.

The package delivery server 102 can determine (206) an appropriate deliver entity for carrying out the delivery service requested by the requesting device 104. As an example, the package delivery server 102 can determine a selected delivery entity based in part on the request data included in the request 202 for delivery transaction, and a database including a set of delivery entities.

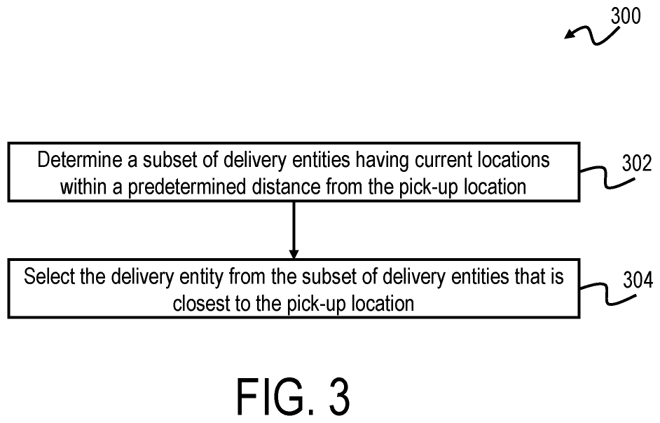

FIG. 3 shows a flow diagram of an example process 300 for selecting a delivery entity. In particular, the process 300 can, in part, be executed by the package delivery server 102 shown in FIGS. 1 and 2. The process 300 includes determining a subset of delivery entities having current locations within a predetermined distance from the pick-up location (302). The predetermined distance can be preset and can be altered so that a minimum number of deliver entities are determined in the subset. The process 300 further includes selecting the delivery entity from the subset of delivery entities that has the lowest cost function in relation to the pick-up location. The cost function can be based on time, distance, a combination of time and distance, or other resources, such as fuel consumption, fuel costs, tolls, etc. For example, the package delivery server 102 can determine the delivery entity that is closest in time, distance, or both from the pick-up location (304). The package delivery server 102 can compare the current locations of each delivery entity form the subset of delivery entities to the pick-up location and select the one that is closest to the pick-up location. In some instances, the package delivery server 102 can access traffic information to determine the estimated time of travel from the current location of the delivery entities to the pick-up location, select the one that is closest in estimated time from the pick-up location. By selecting the delivery entity that is closest to the pick-up location, the package delivery server 102 can potentially reduce the time costs and fuel costs associated with the delivery.

In some examples, the package delivery server 102 can determine the selected delivery entity based on a polling mechanism. For example, the package delivery server 102 can send a polling message to a network address associated with each delivery entity in the subset of delivery entities previously determined. The package delivery server 102 can then receive at least one polling response message from at least one delivery entity from the subset of delivery entities. The package delivery server 102 can select the delivery entity whose polling response message arrived first.

In some examples, the package delivery server can determine the selected delivery entity based on whether the selected entity is currently in a downtime status. The package delivery server 102 can repeatedly receive downtime status from the delivery entities, and store this status in the delivery entities database. The downtime status can indicate that the delivery entity is currently not engaged in a ride-sharing or delivery services. In such instances, the package delivery server 102 can select the delivery entity from the subset of delivery entities that are currently in a downtime state. By selecting a delivery entity that is currently in a downtime state, the package delivery server 102 can potentially decrease the time required for the delivery entity, which is currently idle, to reach the pick-up location. Further, by assigning the delivery to a delivery entity with a downtime status, the cost efficiency of that delivery entity can be potentially increased by decreasing the downtime of the delivery entity.

In yet other examples, the package delivery server 102 can repeatedly receive en-route status from each of the delivery entities and store the en-route status in the delivery entity database. The en-route status can indicate whether the deliver entity is currently engaged executing a ride-sharing service. For example, a delivery entity that is currently en-route to picking up or dropping a ride share passenger, or picking up or dropping off another package can send an en-route status message to the package delivery server 102. By selecting a delivery entity that is already en-route, can reduce the idle time of the delivery entity, reduce the fuel consumption in picking up the package, and increase the efficiency of the delivery infrastructure.

Referring again to FIG. 2, the package delivery server 102, after determining the selected delivery entity, can transmit a delivery message 208 to the selected delivery entity to ascertain that the delivery entity is willing to accept the delivery request. The delivery message 208 can include at least one of a pick-up location of the package, the drop-off location of the package, and the identity information of the user. The delivery message 208 can be delivered to the delivery entity 106 if the delivery entity 106 has the capability to receive messages from the package delivery server 102. The delivery message 208 may alternatively, or in addition, be sent to the network address of the communication device 108 associated with the delivery entity 106.

The communication device 108 associated with the delivery entity 106 can annunciate (210), over at least one user interface of the communication device 108, a receipt of the delivery message 208. As an example, if the communication device 108 includes a display screen, the communication device 108 can display the receipt of the delivery message on the display screen. In some examples, in particular where the communication device 108 includes a digital assistant, the communication device can generate audio to indicate the receipt of the delivery message 208. The communication device 108 also may use a combination of audio and visual modes to indicate the receipt of the delivery message 208.

The communication device 108 can also provide the delivery entity 106 an opportunity (212) to either accept or decline the delivery request associated with the delivery message 208. For example, the communication device 108 can display a user interface that allows the delivery entity 106 to select “Accept” or “Decline” with respect to the received delivery message. The communication device 108 may also utilize audio to ask the delivery entity 106 to select “Accept” or “Decline.” The communication device 108 can use a combination of visual and audio modes to present the delivery entity to accept or decline the delivery message.

The communication device 108 after receiving a response from the delivery entity 106, can transmit the response to the package delivery server 102. For example, if the delivery entity 106 responds to accept the package delivery task, the communication device can transmit an acceptance message 214 to the package delivery server 102. On the other hand, if the delivery entity 106 responds to decline the package delivery task, the communication device 108 can transmit a decline message to the package delivery server 102.

The package delivery server 102, responsive to receiving an acceptance message 214 from the delivery entity 106, can generate a confirmation message 216 for transmission to the requesting device 104. The confirmation message can include a confirmation that the delivery request has been accepted, and can include, in part, identification information of the selected delivery entity 106. The confirmation information also can include billing information, such as the charges for the delivery service.

The package delivery server 102 can also generate direction and routing information from the current location of the selected delivery entity 106 to the pick-up location, and from the pick-up location to the drop-off location associated with the delivery request. The package delivery server 102 can send the direction and routing information to the communication device 108 associated with the selected delivery entity 106 to assist the delivery entity 106 to arrive at the pick-up location, and once the package is picked up, to depart to the drop-off location.

In some examples, the package delivery server 102 can generate shipping label information associated with the package. The shipping label can be transmitted to the selected delivery entity 106 (or the communication device 108 associated with the selected delivery entity 106). The delivery entity 106 can be equipped with a printing device, that can print the printing label, which can be affixed to the package prior to being dropped off at the drop-off location. The package delivery server 102 can also receive package information from the selected delivery entity 106 after the delivery entity 106 arrives at the pick-up location. For example, the delivery entity 106 can carry a portable package weighing machine, which can measure the weight of the package and communicate the weight of the package to the communication device 108. The communication device 108 can include an application that can measure the dimensions of the package based on a photo or live view of the package. The communication device 108 also can allow manual entry of the dimensions and weight of the package. The communication device 108 can transmit the dimensions and weight information to the package delivery server 102, which can use the information to generate shipping label information, and provide the actual shipping costs to the requesting device 104.

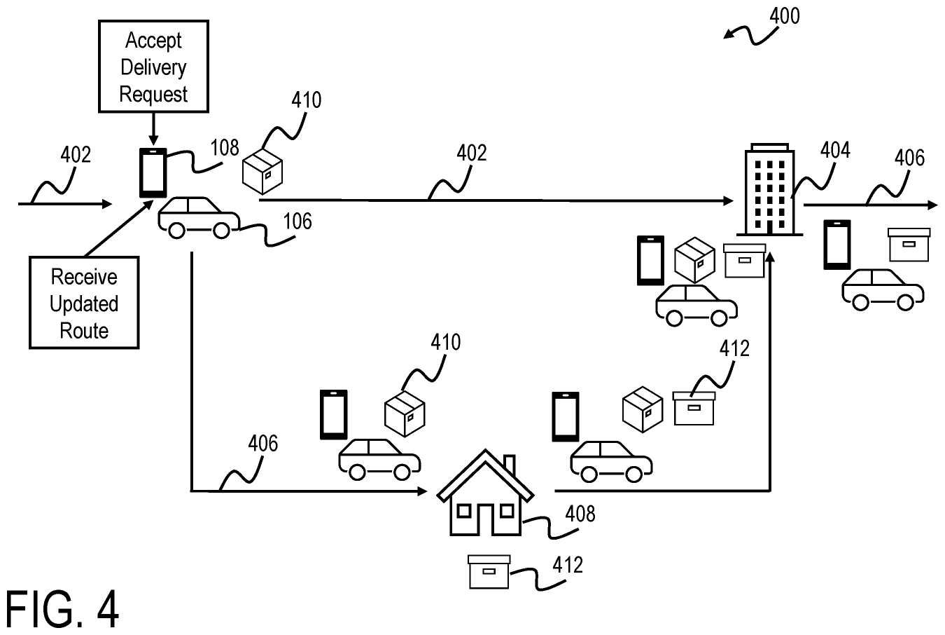

FIG. 4 shows a schematic of an example package delivery infrastructure 400 including chaining of package deliveries. In particular, the delivery infrastructure 400 depicts a scenario where a new package delivery can be chained to an ongoing package delivery being carried out by the delivery entity 106. The delivery entity 106 shown in FIG. 4 can be on a current route 402 for an ongoing service to a first destination 404. The ongoing service can be a current package delivery task to deliver a first package 410 to a first destination 404. The ongoing service may also be an ongoing ride-sharing service, a food delivery service, etc. The communication device 108 associated with the delivery entity 106 can receive a new package delivery message from the package delivery server 102. Upon accepting the package delivery task, the package delivery server 102 can transmit to the communication device 108 a modified route that alters the current route 402 to an alternate route 406 that now includes a new pick-up location 408. The delivery entity 106 can then, instead of continuing on the original route 402, follow the alternate route 406 to the new pick-up location 408 to pick-up a second package 412.

Upon arriving at the pick-up location 408, the package delivery server 102 can receive additional package information such as dimensions and weight from the communication device 108, in a manner similar to that discussed above. The package delivery server 102 can send the shipping label, if required, to the communication device 108 for the delivery entity 106 to print and affix to the second package 412. After picking up the second package 412, the delivery entity 106 can continue on the alternate route 406 to the first destination 404 to drop-off the first package 410. After dropping off the first package 410, the delivery entity 106 can again continue on the altered route 406 to the drop-off location of the second package 412. In this manner, one or more new package deliveries can be chained onto existing package delivery tasks. This can allow the delivery entity 106 to pick-up and drop-off multiple packages the pick-up and drop-off locations of which are relatively close to justify the rerouting of the original route. As a result, the amount of time and resources (such as time and fuel) that would be spent using the chaining approach can be substantially lower than approaches that would involve separate point-to-point deliveries of the packages, thereby reducing the cost in improving the efficiency of the delivery infrastructure.

The package delivery server 102 also can provide photo verification of the packages. In some examples, the requesting device 104 can provide a photo of the package requested to be picked up from the pick-up location. The package delivery server 102 can receive the photo of the package from the requesting device 104 and transmit the photo of the package to the selected delivery entity 106. The package delivery server 102 can instruct the selected delivery entity to capture a photo of the package to be picked up at the pick-up location. The package delivery server 102 may also instruct the selected delivery entity to stand-by until it receives a message to proceed from the package delivery server 102. Upon receiving the photo from the selected delivery entity, the package delivery server 102 can transmit the photo to the requesting device 104 and request verification. Upon receiving a verification message from the requesting device 104, the package delivery server 102 can instruct the selected package delivery entity to pick-up the package and proceed to the drop-off location. In this manner, the requesting device 104 can verify that the package being picked up from the pick-up location is the desired package.

In some examples, the requesting device 104 can take a photo of the package when requesting a delivery transaction. The requesting device 104 can provide the photo to the package delivery server 102, which, in turn, can provide the photo to the selected delivery entity. At the pick-up location, the selected delivery entity can confirm that the package at the pick-up location matches the photo of the package received from the package delivery server 102. The selected delivery entity (or the device associated therewith) can send a message to the package delivery server 102 indicating the verification of the package. Alternatively, or in addition, the selected delivery entity can take a photo of the package being picked up and transmit the photo to the package delivery server 102. The package delivery server 102 can forward both the first photo (received from the requesting device 104) and the second photo (received from the selected delivery entity) to a device associated with a recipient at the drop-off location. The package delivery server 102 can receive the identity and contact details of the device associated with the recipient at the drop-off location from the requesting device, for example. In this manner, the recipient can verify that the package being shipped by the requesting device 104 is the same package that is being picked-up by the selected delivery entity.

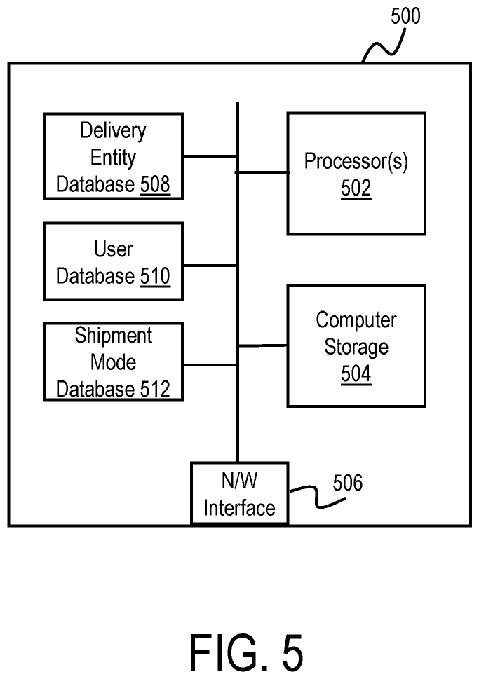

FIG. 5 shows a schematic of an example package delivery server 500. The package delivery server 500 can be used to implement the package delivery server 102 discussed above. The package delivery server 500 can include one or more processors 502, computer storage 504, one or more network interfaces 506, a delivery entity database 508, a user database 510, and a shipment mode database 512. In some examples, the system 500 can be implemented on a personal computer, a server farm, a cloud computing platform, distributed computing platform, or other forms of computing platforms. The one or more processors 502 can include instruction-based processors that can execute instructions stored in the computer storage 504 to perform particular actions specified by the instructions. The one or more processors 502 can be single core or multi-core processors and can include accompanying, cache memory, read-only-memory (ROM) and random-access-memory (RAM) for storing instructions and data for the operation of the one or more processors. The computer storage 504 can store instructions in the form of executable programs that can be accessed by the one or more processors. The computer storage 504 can include non-transitory machine readable media such as hard-disk drives, CD-ROMs, solid state drives, ROM, RAM, etc.

The delivery entity database 508 can store information on the delivery entities, such as the delivery entity 106 discussed above. In particular, the database 508 can include information such as an identity of the delivery entity, contact information of the delivery entity, a network address of a communication device associated with the delivery entity, current location of the delivery entity, current status (en-route, downtime, etc.) of the delivery entity, past delivery transactions of the delivery entity, payment information, etc. The processor 502 can access the database to retrieve and update data related to one or mor delivery entities. The user database 510 can include user information such as, for example, unique identifier associated with a user, identity of a communication device associated with the user, current location of the user, use residence address, user payment information, past delivery transactions of the user, authentication information associated with the user, etc. The processor 502 can retrieve the data associated with the user when, for example, the requesting device associated with the user sends a request for a delivery transaction to the package delivery server. The package delivery server can access the user database 510 to obtain authentication and residence address of the user to authenticate the user and to determine a potential pick-up location. The shipment mode database 512 can include information related to shipment modes specified by the user in the delivery request. For example, the shipment mode database 512 can include information related to various shipping carrier such as USPS, FEDEX, UPS, etc., so that the package delivery server can determine the nearest or the most appropriate drop-off location of a package. While the databases shown in FIG. 5 are located at the package delivery server 500, in some instances, the databases can be located remotely from the package delivery server 500, and can be accessed over a network.

The at least one network interface 506 can allow the processor to communicate over one or more computer networks, such as the Internet, local area networks, wide area networks, cellular networks, private networks, optical networks, etc. The network interface 506 can include one or more network interface cards (NICs) that can interface with one or more networks.

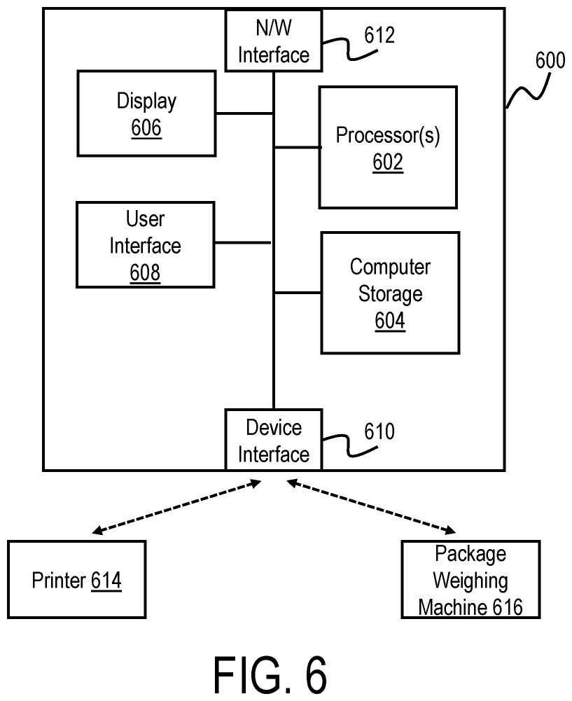

FIG. 6 shows a schematic of an example communication device 600. The communication device 600 can be utilized to implement, for example, the communication device 108 associated with the delivery entity 106 discussed above. The communication device 600 can include one or more processors 602, computer storage 604, a display screen 606, a user interface 608 (including, for example, a keyboard, a microphone, a speaker, etc.), external device interface 610, and a network interface 612. The communication device 600 can include mobile devices such as, for example, a mobile phone, a tablet, a laptop, a digital assistant, arial drone, etc. The one or more processors 602 can include instruction-based processors that can execute instructions stored in the computer storage 604 to perform particular actions specified by the instructions. The one or more processors 602 can be single core or multi-core processors and can include accompanying, cache memory, ROM and RAM for storing instructions and data for the operation of the one or more processors. The computer storage 604 can store instructions in the form of executable programs that can be accessed by the one or more processors 602. For example, the computer storage 604 can store one or more package delivery applications that allow communication with the package delivery server 102 such as those discussed above in relation to FIGS. 1-4. The computer storage 604 can include non-transitory machine readable media such as hard-disk drives, CD-ROMs, solid state drives, ROM, RAM, etc.

The display screen 606 can be used by the processors 602 while executing a package delivery application to annunciate via the display received package delivery requests from the package delivery server, and to prompt the delivery entity 106 to accept or decline the request. The display screen 606 also can display direction and routes for package pick-up and delivery. The user interface 608 can include a keyboard to accept the delivery entity input, a speaker to annunciate audio that indicates the receipt of package delivery requests and driving directions. The microphone can be used to accept for example the voice commands indicating acceptance or denial of the package delivery requests. The external device interface 610 can be used to communicate with external devices such as a printer 614 and a weighing machine 616. The external device interface can be a wired (e.g., USB, Firewire, serial port, parallel port, etc.) interface or a wireless interface (WiFi, Bluetooth, Zigbee, etc.). The communication device 600 can send shipping label information received from the package delivery server to the printer 614 for printing the shipping label, and receive package weight information form the weighing machine to be sent to the package delivery server or used by the application to determine the shipping costs. The at least one network interface 612 can allow the processor 602 to communicate over one or more computer networks, such as the Internet, local area networks, wide area networks, cellular networks, private networks, optical networks, etc. The network interface 506 can include one or more network interface cards (NICs) that can interface with one or more networks. The communication device 600 can communicate with the package delivery server 102 or with the requesting device associated with the user requesting the package delivery.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A system, comprising:
a server system, the server system comprising at least one network interface configured to communicate over a communication network, at least one processor, and instructions stored in non-transitory machine-readable media, the instructions configured to cause the server system to perform operations including:
receive, over the at least one network interface, a request for a delivery transaction from a requesting device, the request including delivery request data including at least one of identity information of a user associated with the requesting device, origination information associated with the request, and a destination information associated with the request;
determine, based at least in part on the delivery request data, a pick-up location and a drop-off location;
determine, based at least in part on the delivery request data and a database including a set of delivery entities and delivery entity information associated with each delivery entity of the set of delivery entities, the delivery entity information including in part current location information of the corresponding delivery entity, an identity of a selected delivery entity from the set of delivery entities;
transmit, over the at least one network interface, a delivery message to a network address associated with the selected delivery entity, the delivery message including at least one of the pick-up location, the drop-off location, and the identity information of the user; and
transmit, over the at least one network interface, a confirmation message to the requesting device, including an identity of the selected delivery entity.

2. The system of claim 1, wherein the instructions cause the server system to:
determine, based on a comparison of the pick-up location with current location information associated with the set of delivery entities in the database, a subset of delivery entities, each of which have a corresponding current location that is within a predetermined distance from the pick-up location, wherein the selected delivery entity has a corresponding current location that has a lowest cost function in relation to the pick-up location from among the subset of delivery entities.

3. The system of claim 1, wherein the instructions cause the server system to:
determine, based on a comparison of the pick-up location with current location information associated with the set of delivery entities in the database, a subset of delivery entities, each of which have a corresponding current location that is within a predetermined distance from the pick-up location;
send, over the at least one network interface, a polling message to a network address associated with each delivery entity in the subset of delivery entities; and
receive, over the at least one network interface, at least one polling response message from at least one delivery entity from the subset of delivery entities, wherein the selected delivery entity corresponds to a first delivery entity from which a polling response message is received.

4. The system of claim 1, wherein the instructions cause the server system to:
receive, over the at least one network interface, a downtime status message from each of a subset of delivery entities of the set of delivery entities, wherein the selected delivery entity belongs to the subset of delivery entities.

5. The system of claim 1, wherein the instructions cause the server system to:
receive, over the at least one network interface, a en-route status from each of a subset of delivery entities of the set of delivery entities, the en-route status indicating a corresponding delivery entity currently engaged in executing a ride-share service; and
determining, from the subset of delivery entities, the selected delivery entity, wherein the selected delivery entity has at least one of its current location or destination location with a lowest cost function in relation to the pick-up location.

6. The system of claim 1, wherein the delivery request data includes mode of shipment information, and wherein the instructions cause the server system to determine the drop-off location based on the mode of shipment information.

7. The system of claim 6, wherein the mode of shipment information indicates a shipment carrier, wherein the instructions cause the server system to:
determine the drop-off location as a location associated with the shipment carrier that is nearest to the pick-up location.

8. The system of claim 7, wherein the destination information associated with the request includes a mailing address associated with a shipment, wherein the instructions cause the server system to:
generate shipment label information specific to the shipment carrier based on the mailing address; and
transmit, over the at least one network interface, the shipment label information to the network address associated with the selected delivery entity.

9. The system of claim 6, wherein the mode of shipment information indicates a courier mode, wherein the destination information includes a location for delivery, wherein the instructions cause the server system to:
determine the drop-off location as the location for delivery.

10. The system of claim 1, wherein the instructions cause the server system to:
receive, over the at least one network interface, another request for a delivery transaction while the delivery entity is en-route to the pick-up location or the drop-off location;
generate a modified route, the modified route modifying a current route to include another pick-up or another drop-off location associated with the another request; and
transmit, over the at least one network interface, the modified route to the selected delivery entity.

11. The system of claim 2, wherein the location that has the lowest cost function in relation to the pick-up location is determined at least in part based on one or more of a distance to the pick-up location, a time to the pick-up location, an efficiency of a route to the pick-up location, an efficiency of resources to the pick-up location.

12. The system of claim 1, wherein the instructions cause the server system to:
receive, over the at least one network interface from the requesting device, a first photo of a package to be picked up from the pick-up location;
transmit, over the at least one network interface to the selected delivery entity, an instruction to capture a photo of the package at the pick-up location;
receive, over the at least one network interface from the selected delivery entity, a second photo of the package at the pick-up location;
transmit, over the at least one network interface to the requesting device, the second photo;
receive, over the at least one network interface from the requesting device, a verification message; and
transmit, over the at least one network interface to the selected delivery entity, an instruction to proceed with delivering the package to the drop-off location.

13. The system of claim 1, wherein the instructions cause the server system to:
receive, over the at least one network interface from the requesting device, a first photo of a package to be picked up at the pick-up location;
transmit, over the at least one network interface to the selected delivery entity, the first photo;
receive, over the at least one network interface, a verification message from the selected delivery entity indicating that the package at the pick-up location matches the first photo;
receive, over the at least one network interface, a second photo of the package at the pick-up location from the selected delivery entity; and
transmit, over the at least one network interface, the first photo and the second photo to a device associated with a recipient at the drop-off location.

14. A mobile device, comprising:
at least one network interface configured to communicate over a communication network, at least one processor, and instructions stored in non-transitory machine-readable media, the instructions configured to cause the mobile device to perform operations including:
receive, over the at least one network interface, a delivery message from a server system, the delivery message including at least one of a pick-up location, a drop-off location, and identity information of a user associated with the delivery message;
annunciate, over at least one user interface of the mobile device, a receipt of the delivery message;
receive, over the at least one user interface, an instruction indicating acceptance of the delivery message;
transmit, responsive to receiving the instruction, over at least one network interface of the mobile device, an acceptance message to the server system;
receive, over the at least one network interface, delivery package information from the server system; and
transmit, to a mobile printer, packaging label information based at least in part on the delivery package information from the server system.

15. The mobile device of claim 14, wherein the instructions cause the mobile device to:
receive, from a mobile weighing scale, weight information of a package associated with the delivery package information; and
generate the packaging label information based at least in part on the weight information.

16. The mobile device of claim 14, wherein the instructions cause the mobile device to:
launch, responsive to receiving the instruction indicating acceptance of the delivery message, a mapping application providing directions from a current location of the mobile device to the pick-up location.

17. The mobile device of claim 14, wherein the instructions cause the mobile device to:
launch, responsive to receiving the delivery package information, a mapping application providing directions from the pick-up location to the drop-off location.

18. The mobile device of claim 14, wherein the instructions cause the mobile device to:
receive, over the at least one network interface, another delivery message from the server system while the mobile device is in route to at least one of the pick-up location or the drop-off location associated with the delivery message;
receive, over the at least one user interface, an instruction indicating acceptance of the delivery message; and
modify a route from a current location to at least one of the pick-up location or the drop-off location associated with the delivery message to include another pick-up location or another drop-off location associated with the delivery message.
